(19) United States
(12) Patent Application Publication
(10) Pub. No.: US 2023/0229533 A1
(43) Pub. Date: Jul. 20, 2023

(54) CONTROL METHOD, COMPUTER-READABLE RECORDING MEDIUM STORING CONTROL PROGRAM, AND INFORMATION PROCESSING APPARATUS

(71) Applicant: Fujitsu Limited, Kawasaki-shi (JP)

(72) Inventor: Koichi Onoue, Kawasaki (JP)

(73) Assignee: Fujitsu Limited, Kawasaki-shi (JP)

(21) Appl. No.: 17/978,359

(22) Filed: Nov. 1, 2022

(30) Foreign Application Priority Data
Jan. 17, 2022 (JP) 2022-005363

(51) Int. Cl. G06F 9/54; G06F 16/27

(52) U.S. Cl. CPC G06F 9/546; G06F 16/275

(57) ABSTRACT

A control method for causing a computer to execute a process that includes transmitting update difference data generated in response to an update of data related to a service provided by a data user to a first message queue, and receiving an initialization request signal for the data related to the service from an apparatus of the data user, and transmitting the data related to the service at a time point of responding to the initialization request signal to a second message queue different from the first message queue.

### CROSS-REFERENCE TO RELATED APPLICATION

This application is based upon and claims the benefit of priority of the prior Japanese Patent Application No. 2022-5363, filed on Jan. 17, 2022, the entire contents of which are incorporated herein by reference.

### FIELD

The embodiment discussed herein is related to a control method, a computer-readable recording medium storing a control program, and an information processing apparatus.

### BACKGROUND

In recent years, it has been difficult to develop a new business area and create a new value only with data of own company. Accordingly, an attempt to create a new business area or value by using data of another company together with the data of the own company has been studied. For example, there is statistical data that an organization that shares data with an external organization may obtain an economic benefit three times or more as compared with an organization that does not share data with the external organization. The external organization that provides data is referred to as a “data provider”, and an organization that provides a service to an end user by using the data provided by the data provider is referred to as a “data user”.

As a method of distributing data from the data provider to the data user, a method of distributing data via a message queue is conceivable. For example, as an existing message queue system, there are Apache Kafka (registered trademark), RabbitMQ (registered trademark), Amazon SQS (registered trademark), Microsoft Message Queuing (registered trademark), and the like.

The method of distributing data via a message queue is a technique in which a data provider transmits data to a message queue at the time of generation and update of data, and a data user receives the data from the message queue to generate and update the data.

The data user acquires data obtained by duplicating entire data in a latest state at that time point when the data is started to be used. In the related art, in a case where a data user acquires data first, the data user acquires the data in an initial state at the time of generation from a message queue, and applies update difference data up to that time point to the acquired data, thereby obtaining a duplicate of the data in a latest state. When acquiring data, acquisition of the data obtained by duplicating the entire data in the latest state at that time point is referred to as data initialization. After that, at the time of data update, the update difference data is provided to the data user by the message queue, and the data user updates the duplicated data to the latest state by using the update difference data.

Advantages of using a message queue for data distribution as described above are as follows. For example, there is an advantage that a data provider may omit additional setting for data distribution due to an increase in the number of data users who provide the same data. A reason for this is that the data provider transmits the data to the message queue instead of the data user and communication between the data provider and the data user may be performed in a one-to-many manner. Another advantage is that the data user may acquire the data from the message queue at a convenient timing. For example, the data may be asynchronously shared between the data provider and the data user. A reason for this is that the data user receives the data from the message queue instead of the data provider.

As a data distribution technique via a message queue, a technique has been proposed in which pieces of data asynchronously sent from a plurality of applications are temporarily stored in a message queue, and the pieces of data are collectively transmitted to an Internet of Things (IoT) device group when a set maximum delay time is reached.

International Publication Pamphlet No. WO 2017/051667 is disclosed as related art.

### SUMMARY

According to an aspect of the embodiments, a control method for causing a computer to execute a process that includes transmitting update difference data generated in response to an update of data related to a service provided by a data user to a first message queue, and receiving an initialization request signal for the data related to the service from an apparatus of the data user, and transmitting the data related to the service at a time point of responding to the initialization request signal to a second message queue different from the first message queue.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a data provision system;

FIG. 2 is a diagram illustrating an example of an initialization processing start request and an initialization processing end request;

FIG. 3 is a diagram illustrating an example of an initialization response;

FIG. 4 is a diagram illustrating an example of an initializing user list;

FIG. 5 is a diagram illustrating an example of transfer data;

FIG. 6 is a first diagram for describing a flow of initialization processing when initialization data exists;

FIG. 7 is a second diagram for describing the flow of the initialization processing when the initialization data exists;

FIG. 8 is a third diagram for describing the flow of the initialization processing when the initialization data exists;

FIG. 9 is a fourth diagram for describing the flow of the initialization processing when the initialization data exists;

FIG. 10 is a fifth diagram for describing the flow of the initialization processing when the initialization data exists;

FIG. 11 is a sixth diagram for describing the flow of the initialization processing when the initialization data exists;

FIG. 12 is a seventh diagram for describing the flow of the initialization processing when the initialization data exists;

FIG. 13 is an eighth diagram for describing the flow of the initialization processing when the initialization data exists;

FIG. 14 is a ninth diagram for describing the flow of the initialization processing when the initialization data exists;

FIG. 15 is a tenth diagram for describing the flow of the initialization processing when the initialization data exists;

FIG. 16 is a first diagram for describing a flow of the initialization processing when the initialization data does not exist;

FIG. 17 is a second diagram for describing the flow of the initialization processing when the initialization data does not exist;

FIG. 18 is a third diagram for describing the flow of the initialization processing when the initialization data does not exist;

FIG. 19 is a fourth diagram for describing the flow of the initialization processing when the initialization data does not exist;

FIG. 20 is a flowchart of initialization processing in a provider server;

FIG. 21 is a flowchart of update processing in a provider server;

FIG. 22 is a flowchart of initialization processing in a user server;

FIG. 23 is a flowchart of update processing in a user server; and

FIG. 24 is a diagram illustrating a hardware configuration of a computer.

### DESCRIPTION OF EMBODIMENTS

In a case where data is distributed via a message queue, when the data is duplicated on the user side by using an update difference from immediately after creation of provided data, an execution time for applying all the differences at the time of data initialization increases in proportion to the number of differences. For example, although the data user acquires entire data at the time of first coupling, when the number of pieces of update difference data included in the message queue is large, the number of times of update increases, and thus it takes time to duplicate the data. Since the data transmitted to the message queue has an expiration date for holding and does not permanently remain, it may be a case where it is difficult for the data user to duplicate the data. For example, when there is data for which an expiration date has expired, it is difficult for the data user to completely duplicate the data. Accordingly, it is difficult to efficiently provide data.

In a technique in which pieces of data temporarily stored in a message queue are collectively transmitted when a maximum delay time is reached, data duplication at the time of data initialization by the data user has not been considered. For this reason, even when this technique is used, it is difficult to shorten the execution time up to the difference application at the time of data initialization and to avoid a failure of data duplication due to data for which an expiration date has expired. Accordingly, it is difficult to efficiently provide data.

Hereinafter, an embodiment of techniques capable of efficiently providing data will be described in detail with reference to the accompanying drawings. The control method, the control program, and the information processing apparatus disclosed in the present application are not limited to the following embodiment.

### Embodiment

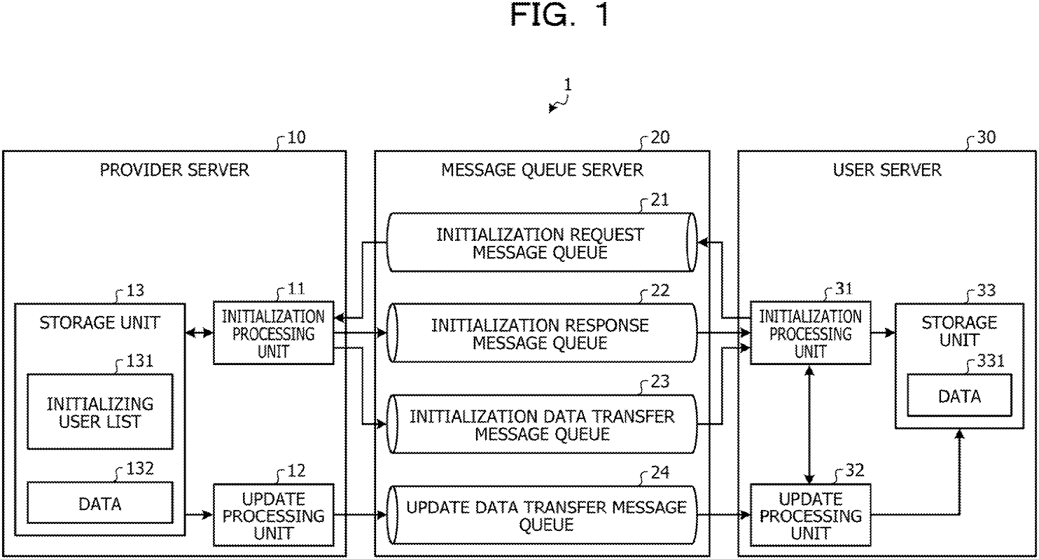

FIG. 1 is a block diagram illustrating a data provision system. A data provision system 1 includes a provider server 10, a message queue server 20, and a user server 30. The user server 30 acquires a duplicate of data related to a service performed by a data user by using data provided from the provider server 10 via the message queue server 20. Processing of acquiring a duplicate of entire data in a latest state at that time point of the data used for the service by the data user is referred to as data initialization. For example, when the data user starts the service, the data user first acquires entire data used for the service from the data provider, and at that time, the data user performs the data initialization. The data used for the duplication in the data initialization is referred to as initialization data. Although the user server 30 actually obtains a duplicate of data held by the provider server 10, there is a case where the following description is provided on an assumption that the user server 30 acquires the data from the provider server 10.

The provider server 10 is an information processing apparatus used for transmitting the data provided by the data provider. The provider server 10 includes an initialization processing unit 11, an update processing unit 12, and a storage unit 13.

The storage unit 13 is a storage apparatus that stores various types of data. For example, the storage unit 13 stores an initializing user list 131 and data 132.

The initializing user list 131 is a list of data users who use an initialization data transfer message queue 23 used for transferring initialization data. A data user who is using the initialization data transfer message queue 23 is registered in the initializing user list 131 by the initialization processing unit 11.

The data 132 is data held by the data provider, that serves as a source from which a data user acquires a duplicate. The data 132 in an initial state is obtained by being generated by the provider server 10 or being acquired from another apparatus. After that, the data 132 is updated from the initial state at any time. The data 132 is latest data when updated, and is used as initialization data provided to the data user at the time of initialization. A timestamp at the time of a last update is added to the data 132.

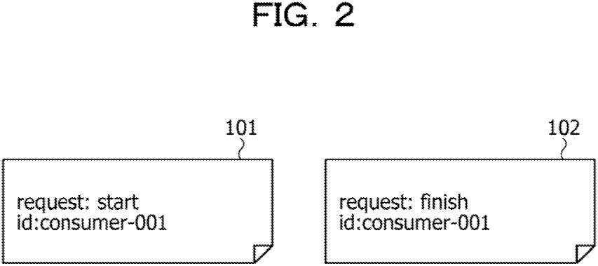

The initialization processing unit 11 receives an initialization processing start request transmitted from the user server 30 via an initialization request message queue 21. FIG. 2 is a diagram illustrating an example of the initialization processing start request and an initialization processing end request. For example, as represented by a syntax 101 in FIG. 2, the initialization processing start request includes a request content and an identifier of the data user. In the syntax 101, the request content is “start”, and the identifier is “consumer-001”. The identifier of the data user may be referred to as an identifier of a data user program that operates in the user server 30 and receives data.

By sending this initialization processing start request from the user server 30 to the provider server 10, the provider server 10 starts the initialization processing, and the data initialization is performed in the user server 30. For example, the initialization processing start request transmitted by an initialization processing unit 31 to the provider server 10 corresponds to an initialization request for requesting execution of initialization. For example, the initialization processing unit 11 receives an initialization request for data related to a service from the user server 30 that is an apparatus of the data user.

Next, the initialization processing unit 11 determines whether the data 132 that is the initialization data exists in the storage unit 13. The initialization data may be data in an initial state or may be data after being updated once or a plurality of times. When the data 132 has been updated, the data in the latest state is used as the initialization data.

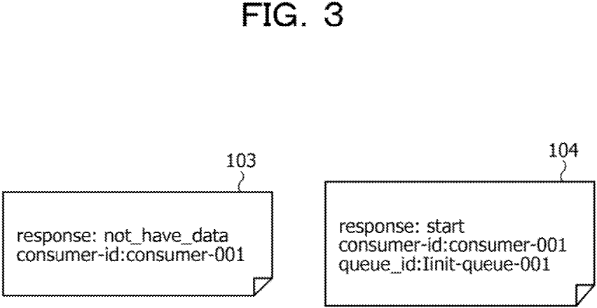

When the initialization data does not exist, the initialization processing unit 11 transmits an initialization response notifying an absence of the initialization data to the user server 30 via an initialization response message queue 22. FIG. 3 is a diagram illustrating an example of the initialization response. For example, as represented by a syntax 103 in FIG. 3, the initialization response notifying the absence of the initialization data includes a response content and an identifier of the data user. For example, as indicated by the syntax 103, the initialization response notifying the absence of the initialization data has a response content such as “not_have_data” indicating that the initialization data does not exist. After that, the initialization processing unit 11 ends the initialization processing.

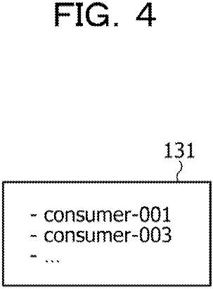

By contrast, when the initialization data exists, the initialization processing unit 11 registers identification information of the data user in the initializing user list 131. FIG. 4 is a diagram illustrating an example of the initializing user list. As illustrated in FIG. 4, the identifiers of the data users who use the initialization data transfer message queue 23 are registered in the initializing user list 131, respectively. For example, in a case where the initialization processing start request having the syntax 101 in FIG. 2 is received, the initialization processing unit 11 registers “consumer-001” in the initializing user list 131.

Next, the initialization processing unit 11 creates the initialization data transfer message queue 23 in the message queue server 20. More specifically, the initialization processing unit 11 requests a control unit (not illustrated) or the like existing in the message queue server 20 to create the initialization data transfer message queue 23, and causes the control unit to create the initialization data transfer message queue 23. In a case where there are a plurality of types of data 132 provided, the initialization processing unit 11 generates the initialization data transfer message queue 23 for each type.

Next, the initialization processing unit 11 transmits an initialization response notifying that the initialization data exists to the user server 30 via the initialization response message queue 22. For example, as represented by a syntax 104 in FIG. 3, the initialization response notifying that the initialization data exists includes a response content, an identifier of the data user, and an identifier of the initialization response message queue 22. For example, the initialization response notifying that the initialization data exists has a response content such as “start” representing the start of the initialization as indicated by the syntax 103, thereby notifying that the initialization data exists. The initialization processing unit 11 may use a predetermined identifier as the identifier of the initialization response message queue 22, or may generate an identifier every time the initialization response message queue 22 is created.

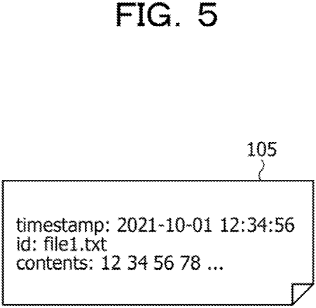

Next, the initialization processing unit 11 acquires the data 132 that is the initialization data. The initialization processing unit 11 transmits the initialization data to the initialization data transfer message queue 23. FIG. 5 is a diagram illustrating an example of transfer data. As indicated by a syntax 105 in FIG. 5, the initialization data includes a timestamp representing a latest update date and time of data, an identifier of data such as a file name, and contents of data represented by a byte string. As described above, the initialization processing unit 11 transmits the data related to the service at the time point of responding to the initialization request to the initialization data transfer message queue 23.

After that, the initialization processing unit 11 receives an initialization processing end request as represented by a syntax 102 in FIG. 2 from the user server 30 via the initialization request message queue 21. The initialization processing unit 11 deletes the identification information of the data user who has transmitted the initialization processing end request from the initializing user list 131. Next, the initialization processing unit 11 determines whether identification information of another data user still exists in the initializing user list 131. When the identification information of another data user still exists in the initializing user list 131, the initialization processing unit 11 waits for arrival of another initialization processing end request.

By contrast, when the identification information of the data user registered in the initializing user list 131 no longer exists, the initialization processing unit 11 deletes the initialization data transfer message queue 23 from the message queue server 20. Also for this deletion, more specifically, the initialization processing unit 11 requests the control unit (not illustrated) or the like existing in the message queue server 20 to delete the initialization data transfer message queue 23, and causes the control unit to delete the initialization data transfer message queue 23. After that, the initialization processing unit 11 ends the initialization processing. As described above, the initialization processing unit 11 registers the identification information of the data user who has transmitted the initialization request in the initializing user list 131, and executes the creation and deletion of the initialization data transfer message queue 23 based on the information registered in the initializing user list 131.

The update processing unit 12 monitors an update of the data 132. When the data 132 is updated, update difference data corresponding to a difference between the data before the update and the data after the update is transmitted to an update data transfer message queue 24. Because it is considered that the entire data 132 is the updated difference when the data 132 in the initial state is stored in the storage unit 13, the update processing unit 12 transmits the entire data 132 in the initial state as the update difference data to the update data transfer message queue 24. The update difference data also has a format indicated by the syntax 105 in FIG. 5. For example, the update processing unit 12 transmits update difference data generated in response to the update of the data related to the service provided by the data user to the update data transfer message queue 24.

Next, the message queue server 20 is described. The message queue server 20 has the initialization request message queue 21, the initialization response message queue 22, and the update data transfer message queue 24 in advance. The update data transfer message queue 24 corresponds to an example of a “first message queue”. The initialization request message queue 21 corresponds to an example of a “third message queue”. The initialization response message queue 22 corresponds to an example of a “fourth message queue”.

In a case where the initialization data exists in the provider server 10 when the user server 30 requests initialization, the initialization data transfer message queue 23 is created by the initialization processing unit 11 of the provider server 10. After that, when the initialization processing ends and the user server 30 that uses the initialization data transfer message queue 23 for data initialization no longer exists, the initialization data transfer message queue 23 is deleted by the initialization processing unit 11 of the provider server 10. The initialization data transfer message queue 23 corresponds to an example of a “second message queue”.

Next, the user server 30 is described. As illustrated in FIG. 1, the user server 30 has an initialization processing unit 31, an update processing unit 32, and a storage unit 33.

The storage unit 33 is a storage apparatus that stores various types of data. For example, the storage unit 33 stores data 331 obtained by duplicating the data 132.

Upon receiving an instruction to execute initialization processing from the user, the initialization processing unit 31 transmits an initialization processing start request to the initialization request message queue 21. After that, in a case where the initialization data does not exist in the provider server 10 at the time point of transmitting the initialization processing start request, the initialization processing unit 31 receives an initialization response notifying completion of the initialization from the provider server 10 via the initialization response message queue 22. The initialization processing unit 31 notifies the update processing unit 32 of 0 as a timestamp of the initialization data. After that, the initialization processing unit 31 ends the initialization processing.

By contrast, when the initialization data exists, the initialization processing unit 31 receives an initialization response notifying that the initialization data exists from the provider server 10 via the initialization response message queue 22. Next, the initialization processing unit 31 acquires identification information of the initialization data transfer message queue 23 included in the initialization response. Next, the initialization processing unit 31 acquires initialization data from the initialization data transfer message queue 23 indicated by the identifier. By using the acquired initialization data, the initialization processing unit 31 generates the data 331 that is a duplicate of the data 132, and stores the data in the storage unit 33.

After storing the data 331, the initialization processing unit 31 transmits an initialization processing end request to the provider server 10 via the initialization request message queue 21. The initialization processing unit 31 notifies the update processing unit 32 of a timestamp added to the data at the time of initialization. After that, the initialization processing unit 31 ends the initialization processing.

At the time of executing the data initialization processing, the update processing unit 32 acquires the timestamp of the initialization data from the initialization processing unit 31. In a case where the initialization data does not exist at the time of executing the data initialization processing, the update processing unit 32 acquires 0 as the timestamp of the initialization data. By contrast, in a case where the initialization data exists at the time of executing the data initialization processing, the update processing unit 32 acquires the timestamp added to the initialization data as the timestamp of the initialization data.

Although the timestamp of the initialization data is acquired from the initialization processing unit 31 at the time of executing the initialization processing in the present embodiment, an acquisition timing is not limited to this as long as the update processing unit 32 holds a timestamp at the time point of determining whether to update the data 331. For example, when determining whether to update the data 331, the update processing unit 32 may transmit an acquisition request for the timestamp of the initialization data to the initialization processing unit 31, and may acquire the timestamp of the initialization data from the initialization processing unit 31.

At a predetermined timing, the update processing unit 32 refers to the update data transfer message queue 24 to confirm the presence or absence of update difference data stored after a previous acquisition of the update difference data. The predetermined timing may be periodic or may be a timing at which an update instruction is received from an operator of the user server 30.

When the update difference data stored after the previous acquisition of the update difference data exists, the update processing unit 32 acquires the update difference data stored after the previous acquisition of the update difference data from the update data transfer message queue 24. In a case where the initialization data does not exist at the time of executing the initialization processing, the update processing unit 32 acquires update difference data including the entire data 132 in the initial state stored after the initialization as the update difference data.

Next, the update processing unit 32 compares a timestamp of the acquired update difference data with a timestamp of the initialization data. In a case where the timestamp of the update difference data is later than the timestamp of the initialization data, the update processing unit 32 updates the data 331 by using the acquired update difference data.

In a case where the initialization data does not exist at the time of executing the initialization processing, the timestamp of the initialization data is 0, and thus the update processing unit 32 updates the data 331 by using the update difference data at all times. For example, in a case where the update difference data is first update difference data when the initialization data does not exist at the time of executing the initialization processing, the update processing unit 32 newly generates the data 331 by using the acquired update difference data and stores the data in the storage unit 33. After the data 331 is updated, the update processing unit 32 ends the data update processing and waits until a next update timing.

In a case where the initialization data exists at the time of executing the initialization processing and the update processing unit 32 acquires the update difference data in a state where the data 132 is not updated after the initialization, the timestamp of the update difference data is not later than the timestamp of the initialization data. In this case, the update processing unit 32 waits until the next update timing without performing update using the update difference data.

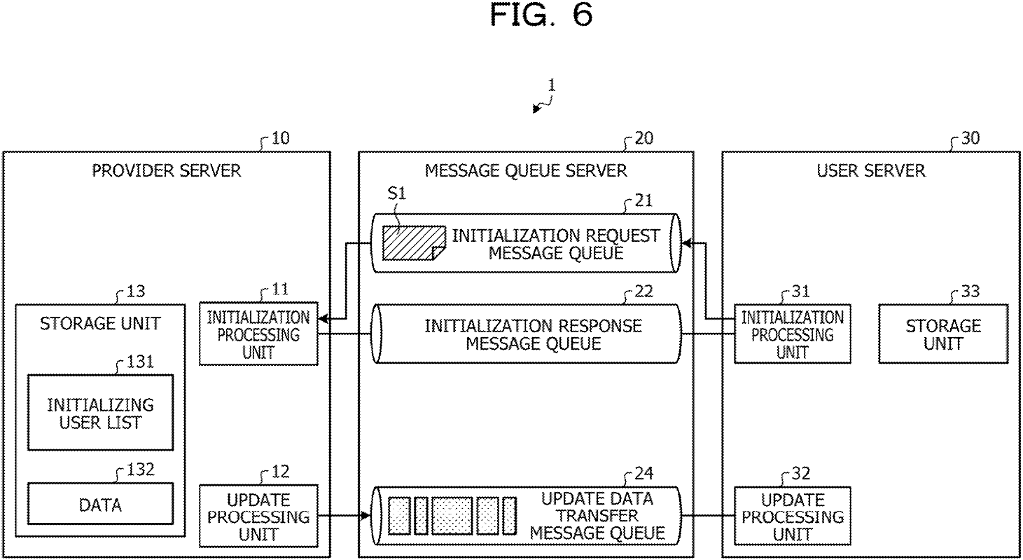

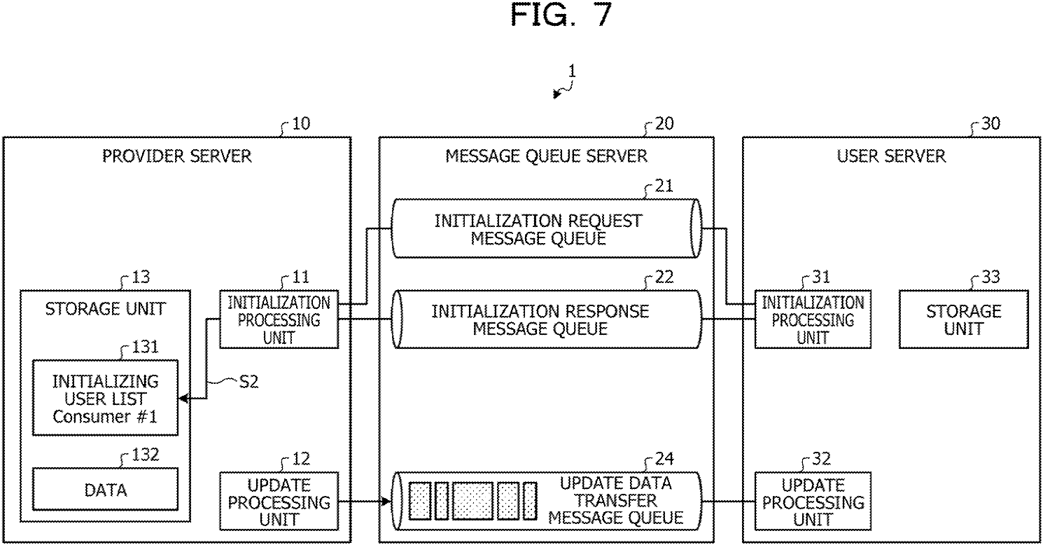

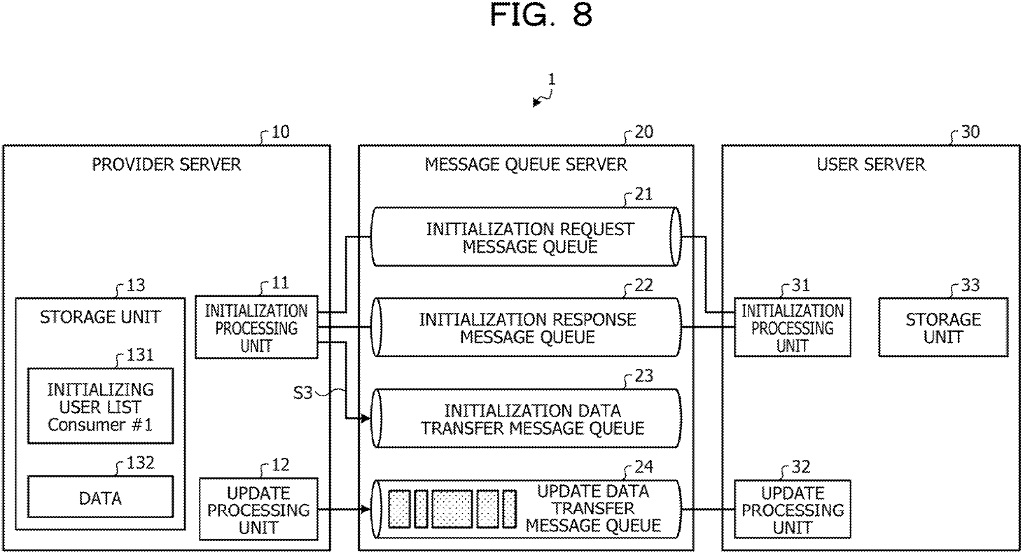

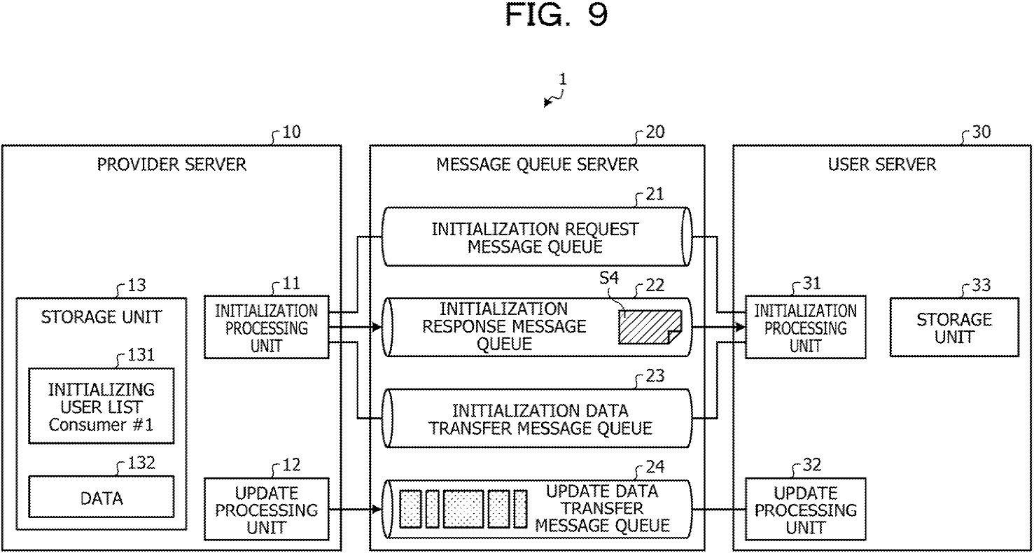

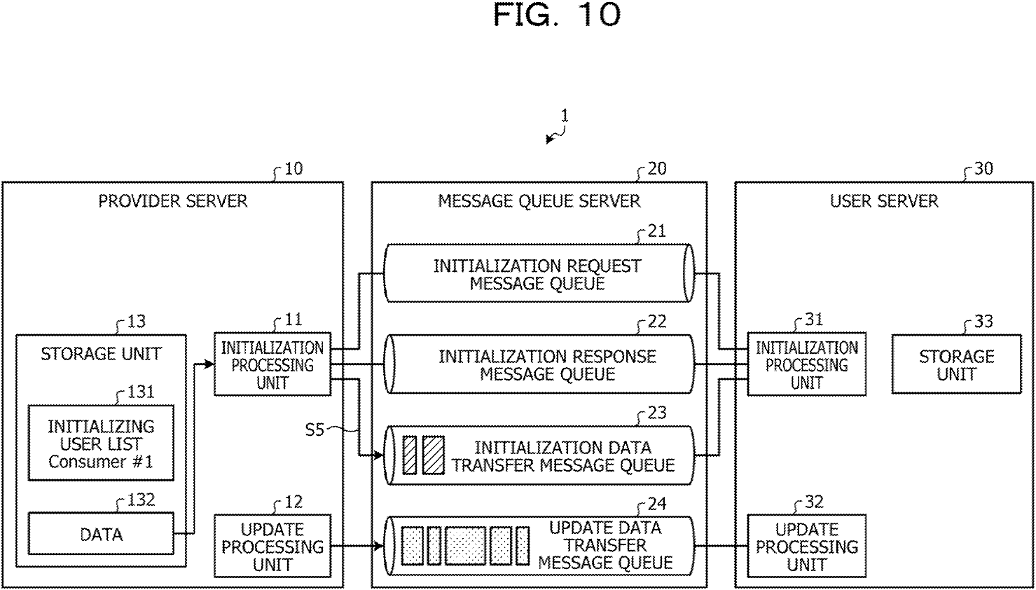

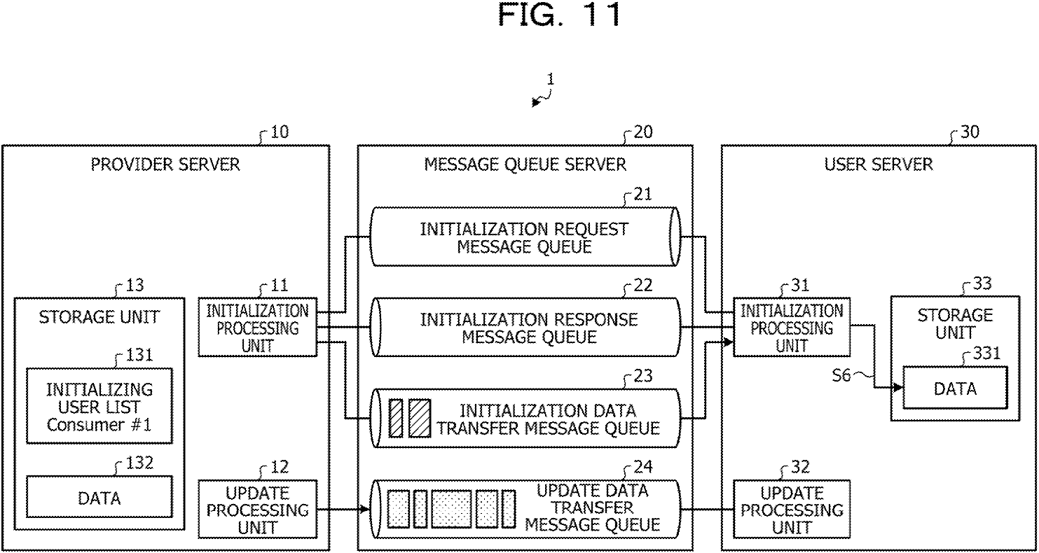

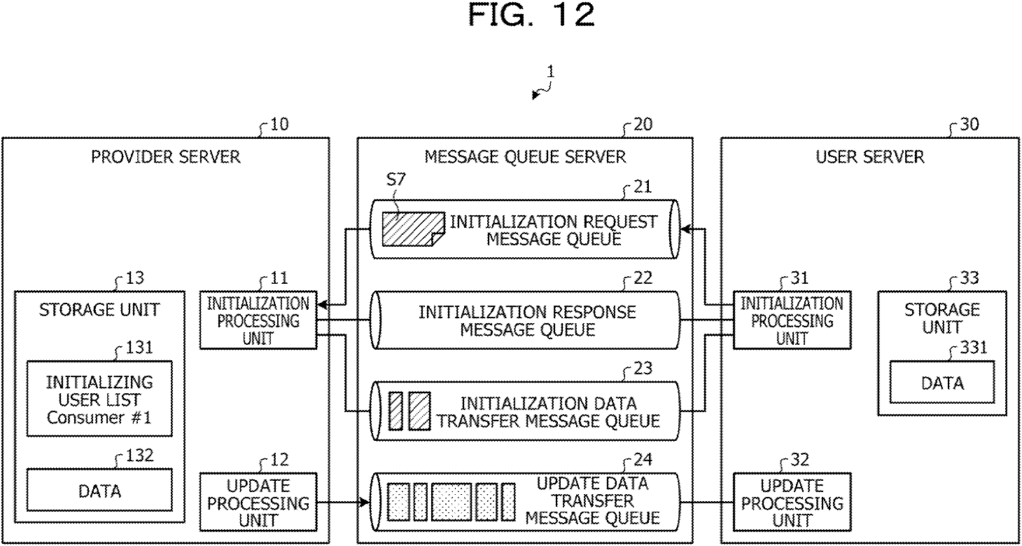

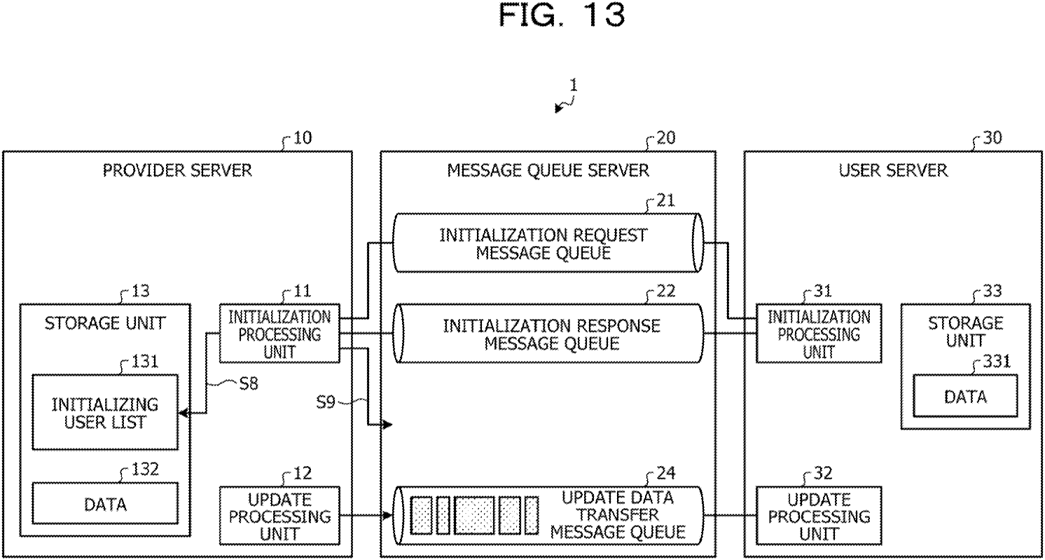

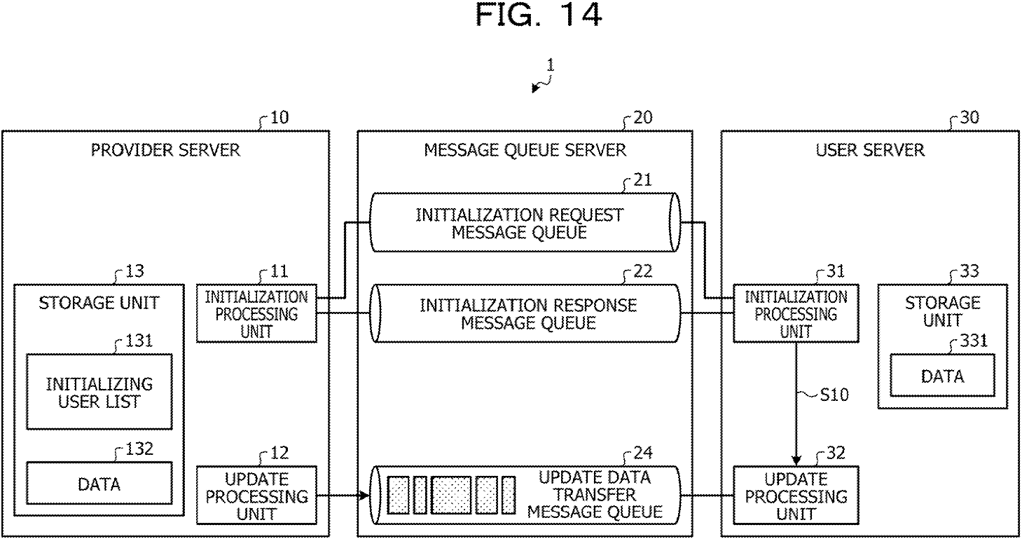

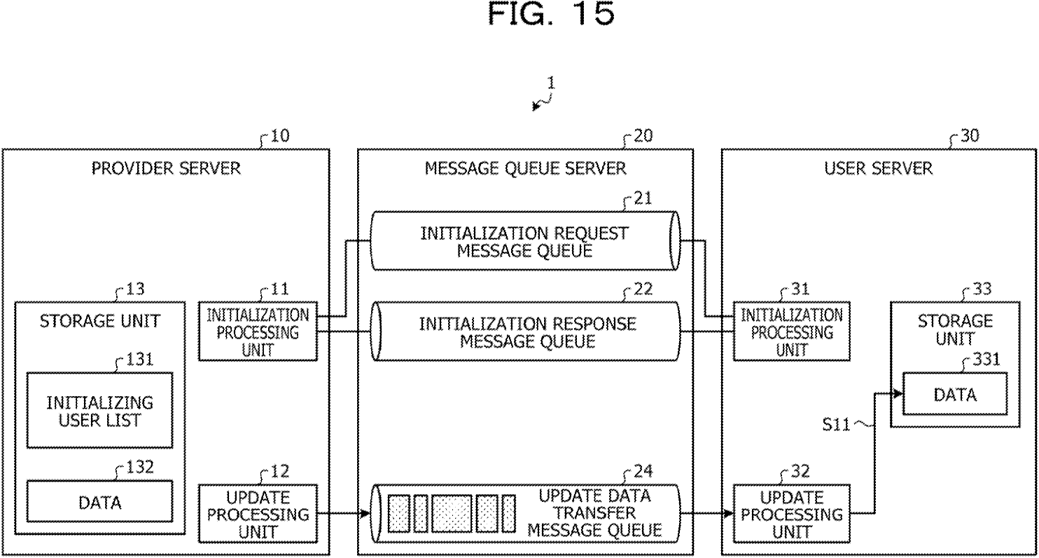

FIG. 6 is a first diagram for describing a flow of the initialization processing when the initialization data exists. FIG. 7 is a second diagram for describing the flow of the initialization processing when the initialization data exists. FIG. 8 is a third diagram for describing the flow of the initialization processing when the initialization data exists. FIG. 9 is a fourth diagram for describing the flow of the initialization processing when the initialization data exists. FIG. 10 is a fifth diagram for describing the flow of the initialization processing when the initialization data exists. FIG. 11 is a sixth diagram for describing the flow of the initialization processing when the initialization data exists. FIG. 12 is a seventh diagram for describing the flow of the initialization processing when the initialization data exists. FIG. 13 is an eighth diagram for describing the flow of the initialization processing when the initialization data exists. FIG. 14 is a ninth diagram for describing the flow of the initialization processing when the initialization data exists. FIG. 15 is a tenth diagram for describing the flow of the initialization processing when the initialization data exists. Hereinafter, an entire flow of the initialization processing in a case where the initialization data exists is collectively described with reference to FIGS. 6 to 15.

As illustrated in FIG. 6, upon receiving an instruction from the user, the initialization processing unit 31 of the user server 30 sends an initialization processing start request to the initialization processing unit 11 of the provider server 10 via the initialization request message queue 21 (operation S1). At this time, the update processing unit 12 transmits update difference data to the update data transfer message queue 24 every time the data 132 is updated, separately from the initialization processing unit 31.

The initialization processing unit 11 of the provider server 10 receives the initialization processing start request. The initialization processing unit 11 confirms the presence or absence of the data 132 that is initialization data. In this case, the data 132 exists in the storage unit 13. As illustrated in FIG. 7, the initialization processing unit 11 registers identification information of the data user that is a transmission source of the initialization processing start request in the initializing user list 131 (operation S2). In FIG. 7, the identification information of the data user is represented as “Consumer #1”.

Next, as illustrated in FIG. 8, the initialization processing unit 11 creates the initialization data transfer message queue 23 in the message queue server 20 (operation S3).

Next, as illustrated in FIG. 9, the initialization processing unit 11 transmits an initialization response notifying that the initialization data exists to the user server 30 via the initialization response message queue 22 (operation S4).

Next, as illustrated in FIG. 10, the initialization processing unit 11 acquires latest data 132 from the storage unit 13. The initialization processing unit 11 transmits the latest data 132 to the initialization data transfer message queue 23 as the initialization data (operation S5).

Next, as illustrated in FIG. 11, the initialization processing unit 31 of the user server 30 acquires the initialization data from the initialization data transfer message queue 23. By using the acquired initialization data, the initialization processing unit 31 generates data 331, which is a duplicate of the data 132, and stores the generated data in the storage unit 33 (operation S6).

After storing the data 331, as illustrated in FIG. 12, the initialization processing unit 31 transmits an initialization processing end request to the provider server 10 via the initialization request message queue 21 (operation S7).

The initialization processing unit 11 of the provider server 10 receives the initialization processing end request. As illustrated in FIG. 13, the initialization processing unit 11 deletes the identification information of the data user that is the transmission source of the initialization processing end request from the initializing user list 131 (operation S8). The initialization processing unit 11 deletes the initialization data transfer message queue 23 from the message queue server 20 (operation S9).

The initialization processing unit 31 of the user server 30 transmits a timestamp added to the initialization data to the update processing unit 32. The update processing unit 32 acquires the timestamp of the initialization data (operation S10).

After that, when the data 132 is updated, the update processing unit 12 of the provider server 10 transmits update difference data to the update data transfer message queue 24. At a predetermined timing, the update processing unit 32 of the user server 30 confirms the presence or absence of update difference data stored after the previous acquisition of the update difference data. As illustrated in FIG. 15, when the update difference data exists, the update processing unit 32 acquires the update difference data stored after the previous acquisition of the update difference data from the update data transfer message queue 24. The update processing unit 32 determines whether a timestamp of the acquired update difference data is later than the timestamp of the initialization data. When the timestamp of the acquired update difference data is later than the timestamp of the initialization data, the update processing unit 32 updates the data 331 by using the update difference data (operation S11).

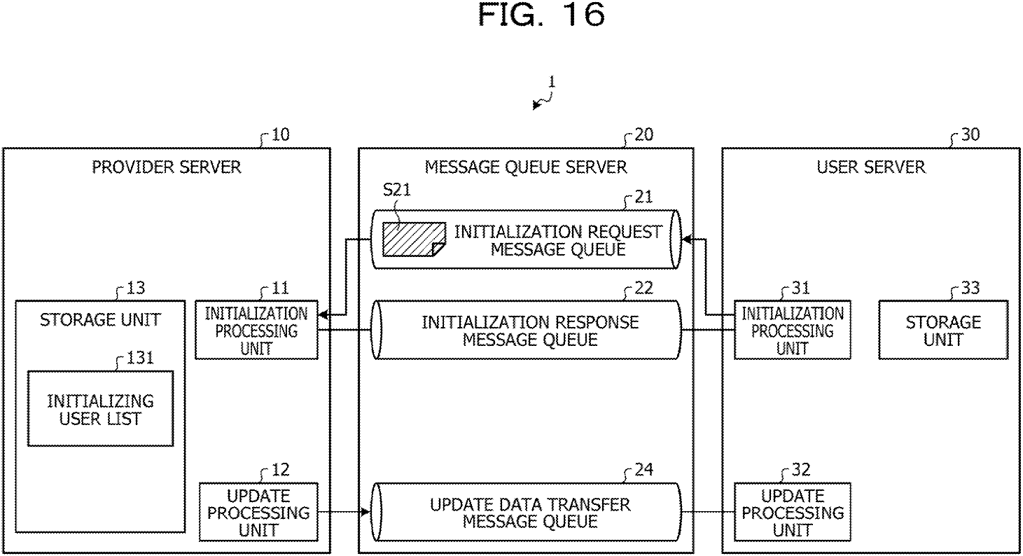

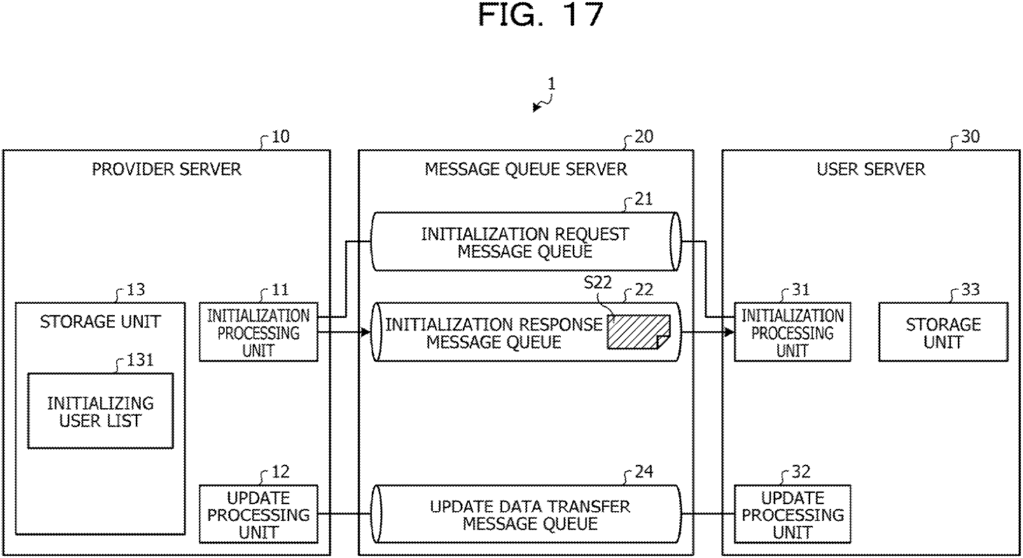

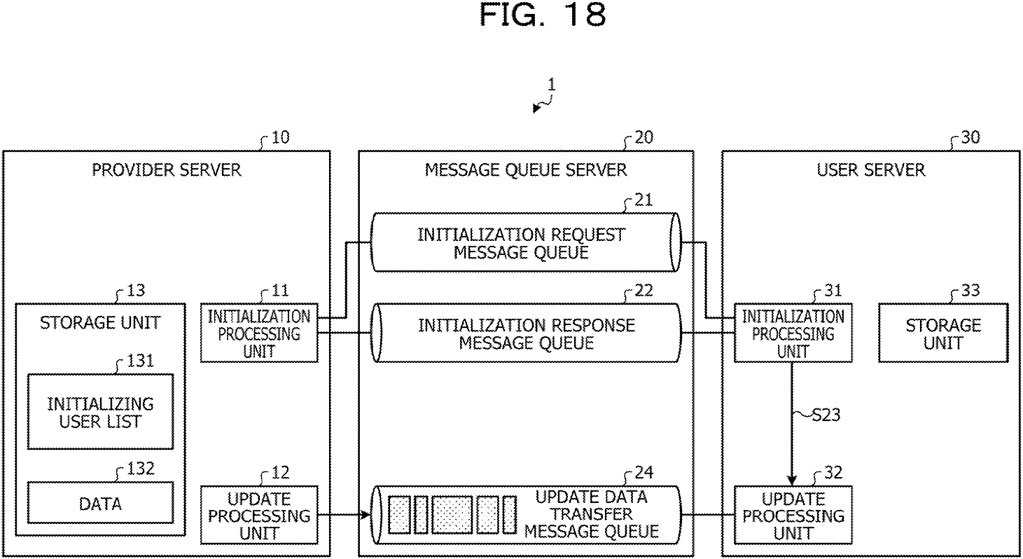

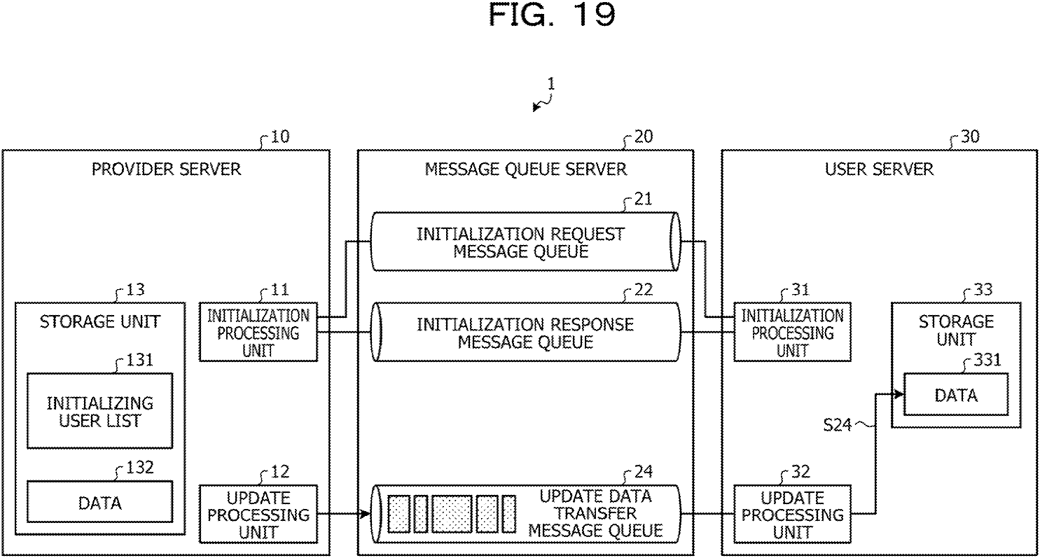

FIG. 16 is a first diagram for describing a flow of the initialization processing when the initialization data does not exist. FIG. 17 is a second diagram for describing the flow of the initialization processing when the initialization data does not exist. FIG. 18 is a third diagram for describing the flow of the initialization processing when the initialization data does not exist. FIG. 19 is a fourth diagram for describing the flow of the initialization processing when the initialization data does not exist. Hereinafter, the entire flow of the initialization processing in a case where the initialization data does not exist is collectively described with reference to FIGS. 16 to 19.

As illustrated in FIG. 16, upon receiving an instruction from the user, the initialization processing unit 31 of the user server 30 sends an initialization processing start request to the initialization processing unit 11 of the provider server 10 via the initialization request message queue 21 (operation S21).

The initialization processing unit 11 of the provider server 10 receives the initialization processing start request. Next, as illustrated in FIG. 17, the initialization processing unit 11 transmits an initialization response notifying an absence of the initialization data to the user server 30 via the initialization response message queue 22 (operation S22).

As illustrated in FIG. 18, when the initialization processing unit 31 of the user server 30 receives the initialization response notifying the absence of the initialization data, the initialization processing unit 31 transmits 0 as a timestamp of the initialization data to the update processing unit 32. The update processing unit 32 acquires 0 as the timestamp of the initialization data (operation S23).

After that, when the data 132 is updated, the update processing unit 12 of the provider server 10 transmits update difference data to the update data transfer message queue 24. At a predetermined timing, the update processing unit 32 of the user server 30 confirms the presence or absence of update difference data stored after the previous acquisition of the update difference data. As illustrated in FIG. 19, when the update difference data exists, the update processing unit 32 acquires the update difference data stored after the previous acquisition of the update difference data from the update data transfer message queue 24. In a case of the first acquisition of the update difference data, the update difference data includes entire data 132 in an initial state. The update processing unit 32 determines whether a timestamp of the acquired update difference data is later than the timestamp of the initialization data. In this case, since the timestamp of the initialization data is 0, the timestamp of the acquired update difference data is normally later than the timestamp of the initialization data. Accordingly, the update processing unit 32 generates the data 331 by using the update difference data and stores the data 331 in the storage unit 33 or updates the data 331 stored in the storage unit 33 (operation S24).

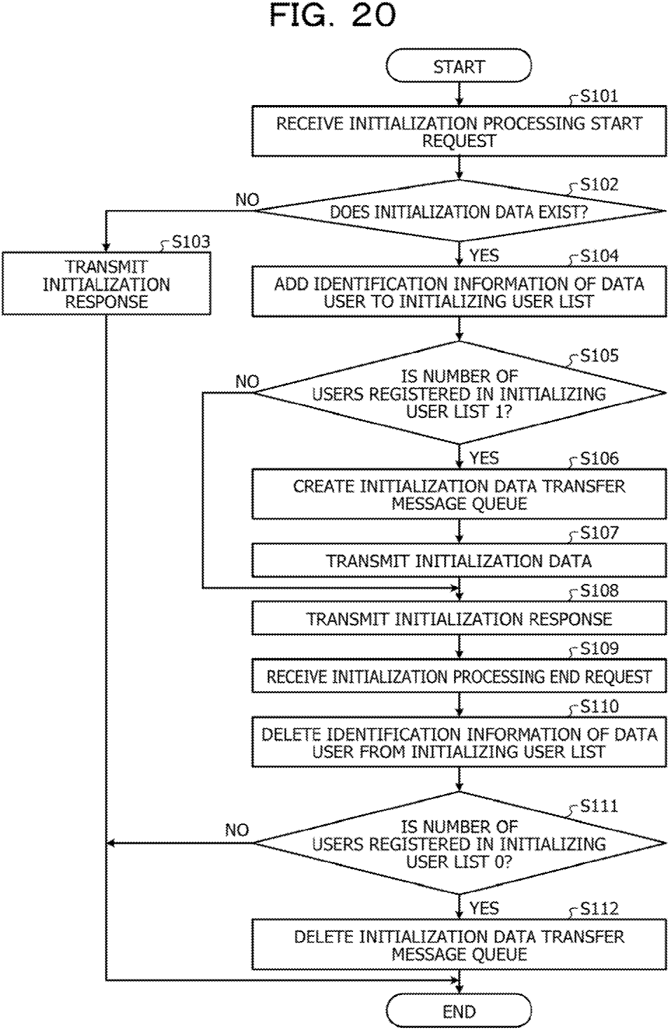

FIG. 20 is a flowchart of the initialization processing in the provider server. Next, a flow of the initialization processing in the provider server 10 is described with reference to FIG. 20.

The initialization processing unit 11 receives an initialization processing start request from the initialization processing unit 31 of the user server 30 via the initialization request message queue 21 (operation S101).

Next, the initialization processing unit 11 determines whether the data 132 that is the initialization data exists (operation S102).

When the initialization data does not exist (operation S102: No), the initialization processing unit 11 transmits an initialization response notifying an absence of the initialization data to the initialization processing unit 31 of the user server 30 via the initialization response message queue 22 (operation S103). After that, the initialization processing unit 11 ends the initialization processing.

By contrast, when the initialization data exists (operation S102: Yes), the initialization processing unit 11 adds identification information of the data user to the initializing user list 131 (operation S104).

Next, the initialization processing unit 11 determines whether the number of users registered in the initializing user list 131 is 1 (operation S105). When the number of users registered in the initializing user list 131 is not 1 (operation S105: No), the initialization processing unit 11 proceeds to operation S108.

By contrast, when the number of users registered in the initializing user list 131 is 1 (operation S105: Yes), the initialization processing unit 11 creates the initialization data transfer message queue 23 in the message queue server 20 (operation S106).

Next, the initialization processing unit 11 acquires the data 132 from the storage unit 13 and transmits the data 132 as the initialization data to the initialization data transfer message queue 23 (operation S107).

After that, the initialization processing unit 11 transmits an initialization response notifying that the initialization data exists to the initialization processing unit 31 of the user server 30 via the initialization response message queue 22 (operation S108).

After duplicating of the data 132 in the user server 30 is completed, the initialization processing unit 11 receives an initialization processing end request from the initialization processing unit 31 of the user server 30 (operation S109).

Next, the initialization processing unit 11 deletes the identification information of the data user that is the transmission source of the initialization processing end request from the initializing user list 131 (operation S110).

Next, the initialization processing unit 11 determines whether the number of users registered in the initializing user list 131 is 0 (operation S111). When the number of users registered in the initializing user list 131 is not 0 (operation S111: No), the initialization processing unit 11 ends the initialization processing.

By contrast, when the number of users registered in the initializing user list 131 is 0 (operation S111: Yes), the initialization processing unit 11 deletes the initialization data transfer message queue 23 (operation S112). After that, the initialization processing unit 11 ends the initialization processing.

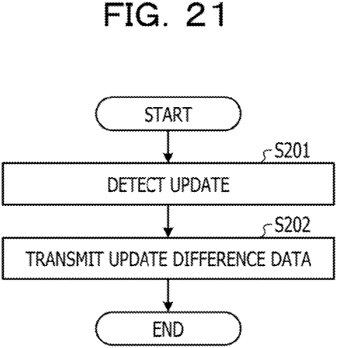

FIG. 21 is a flowchart of the update processing in the provider server. Next, a flow of the update processing in the provider server 10 is described with reference to FIG. 21.

The update processing unit 12 detects an update of the data 132 stored in the storage unit 13 (operation S201).

After detecting the update of the data 132, the update processing unit 12 transmits update difference data, which is a difference due to the update, to the update processing unit 32 of the user server 30 via the update data transfer message queue 24 (operation S202).

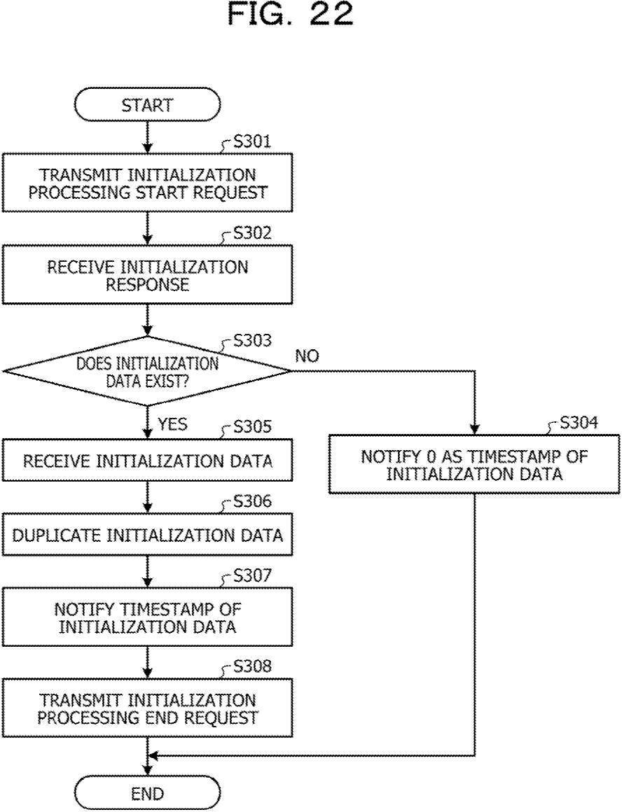

FIG. 22 is a flowchart of the initialization processing in the user server. Next, a flow of the initialization processing in the user server 30 is described with reference to FIG. 22.

Upon receiving an instruction from the user, the initialization processing unit 31 transmits an initialization processing start request to the initialization processing unit 11 of the provider server 10 via the initialization request message queue 21 (operation S301).

After that, the initialization processing unit 31 receives an initialization response via the initialization response message queue 22 (operation S302).

Next, the initialization processing unit 31 determines whether initialization data exists from a response content of the acquired initialization response (operation S303).

When the initialization data does not exist (operation S303: No), the initialization processing unit 31 notifies the update processing unit 32 of 0 as a timestamp of the initialization data (operation S304).

By contrast, when the initialization data exists (operation S303: Yes), the initialization processing unit 31 receives the initialization data via the initialization data transfer message queue 23 (operation S305).

Next, the initialization processing unit 31 generates data 331, which is a duplicate of the initialization data, and stores the generated data in the storage unit 33 (operation S306).

Next, the initialization processing unit 31 notifies the update processing unit 32 of the timestamp of the initialization data (operation S307).

Next, the initialization processing unit 31 transmits an initialization processing end request to the initialization processing unit 11 of the provider server 10 via the initialization request message queue 21 (operation S308). After that, the initialization processing unit 31 ends the initialization processing.

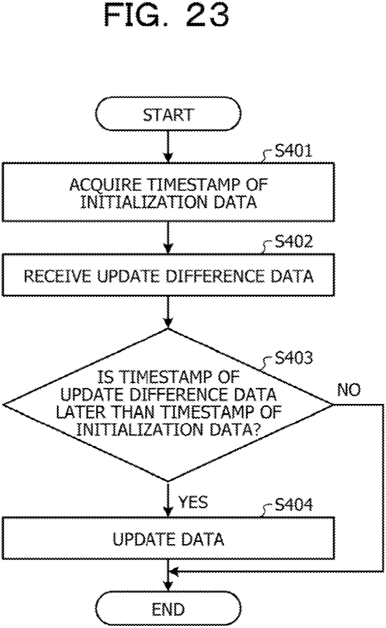

FIG. 23 is a flowchart of the update processing in the user server. Next, a flow of the update processing in the user server 30 is described with reference to FIG. 23.

At the time of executing the initialization processing, the update processing unit 32 acquires the timestamp of the initialization data from the initialization processing unit 31 (operation S401).

Next, the update processing unit 32 receives update difference data from the update data transfer message queue 24 (operation S402).

Next, the update processing unit 32 determines whether a timestamp of the update difference data is later than the timestamp of the initialization data (operation S403). When the timestamp of the update difference data is not later than the timestamp of the initialization data (operation S403: No), the update processing unit 32 ends the update processing.

By contrast, when the timestamp of the update difference data is later than the timestamp of the initialization data (operation S403: Yes), the update processing unit 32 uses the update difference data to update the data 331 stored in the storage unit 33 (operation S404). After that, the update processing unit 32 ends the update processing.

### Hardware Configuration

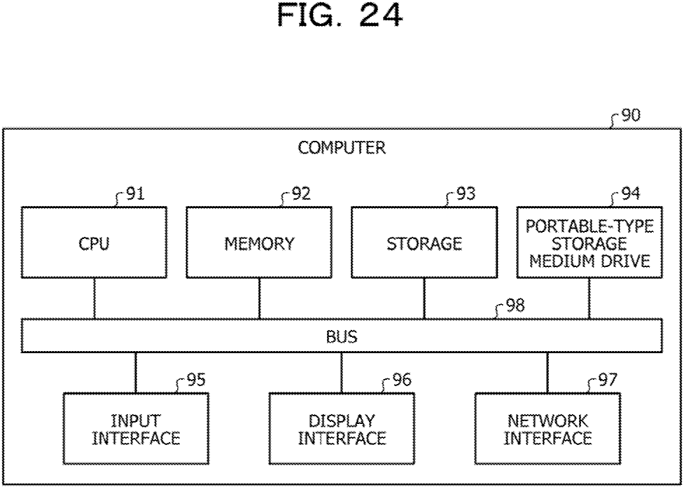

FIG. 24 is a diagram illustrating a hardware configuration of a computer. Any of the provider server 10, the message queue server 20, and the user server 30 may be implemented by a computer 90 illustrated in FIG. 24.

As illustrated in FIG. 24, the computer 90 includes a central processing unit (CPU) 91, a memory 92, a storage 93, a portable-type storage medium drive 94, an input interface 95, a display interface 96, a network interface 97, and a bus 98. The CPU 91 is coupled to the memory 92, the storage 93, the portable-type storage medium drive 94, the input interface 95, the display interface 96, and the network interface 97 via the bus 98.

The storage 93 is a hard disk or a solid-state drive (SSD). For the provider server 10, the storage 93 implements a function of the storage unit 13, and for the user server 30, the storage 93 implements a function of the storage unit 33. For example, the storage 93 stores various programs such as an operating system (OS) and an application program, and program data. For example, in the case of the provider server 10, the storage 93 stores a program for implementing functions of the initialization processing unit 11 and the update processing unit 12 exemplified in FIG. 1. In the case of the user server 30, the storage 93 stores a program for implementing functions of the initialization processing unit 31 and the update processing unit 32 exemplified in FIG. 1. In the case of the message queue server 20, the storage 93 implements functions of the initialization request message queue 21, the initialization response message queue 22, the initialization data transfer message queue 23, and the update data transfer message queue 24.

A removable storage medium such as a magnetic disk and an optical disk is inserted into the portable-type storage medium drive 94, for example. The portable-type storage medium drive 94 writes and reads data to and from the inserted storage medium.

The input interface 95 is coupled to an input apparatus such as a keyboard and a mouse. A display apparatus such as a monitor is coupled to the display interface 96.

The network interface 97 is an interface for communication with an external apparatus. For example, the network interface 97 relays communication between the provider server 10 and the message queue server 20 and communication between the message queue server 20 and the user server 30.

The memory 92 is a main storage apparatus. As the memory 92, for example, a dynamic random-access memory (DRAM) or the like may be used.

The CPU 91 reads various programs stored in the storage 93, develops the programs in the memory 92, and executes the programs. Accordingly, in the case of the provider server 10, the CPU 91 implements functions of the initialization processing unit 11 and the update processing unit 12 exemplified in FIG. 1. In the case of the user server 30, the CPU 91 implements functions of the initialization processing unit 31 and the update processing unit 32 exemplified in FIG. 1. In the case of the message queue server 20, the CPU 91 implements functions of creating and deleting the initialization data transfer message queue 23 in the storage 93 upon receiving an instruction from the provider server 10.

As described above, in the data provision system according to the present embodiment, when the provider server receives an initialization request and the initialization data exists, the provider server generates an initialization data transfer message queue. By using the initialization data transfer message queue, the provider server transfers latest data as the initialization data. When performing the data initialization, the user server acquires the initialization data by using the initialization data transfer message queue and generates a duplicate of the entire latest data.

Accordingly, the number of application times of the update difference at the time of data initialization may be reduced, and the time at the time of data initialization may be shortened. Complete data initialization may be performed without depending on the expiration date of the data stored in the message queue. Accordingly, it is possible to efficiently provide data. Accordingly, it is possible to reduce the cost caused by the data initialization, such as the number of application times of update difference data, application time, and machine addition. Because the above-described data initialization may be implemented by using a mechanism of the message queue, both the data user and the data provider may easily introduce the data provision system according to the present embodiment without introducing a new mechanism.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control method for causing a computer to execute a process, the process comprising:
transmitting update difference data generated in response to an update of data related to a service provided by a data user to a first message queue;
receiving an initialization request signal for the data related to the service from an apparatus of the data user; and
transmitting the data related to the service at a time point of responding to the initialization request signal to a second message queue different from the first message queue.

2. The control method according to claim 1, further comprising:
acquiring the initialization request signal from a third message queue different from the first message queue and the second message queue; and
transmitting a response signal to the initialization request signal to a fourth message queue different from the first message queue, the second message queue, and the third message queue.

3. The control method according to claim 1, further comprising:
registering identification information of the data user who has transmitted the initialization request signal in an initializing user list, and executing creation or deletion of the second message queue, based on the identification information registered in the initializing user list.

4. The control method according to claim 1,
wherein, upon receiving the initialization request signal,
when the data related to the service is held, a response signal notifying that the data related to the service exists is transmitted to the fourth message queue, and the data related to the service at the time point of responding to the initialization request signal is transmitted to the second message queue, and
when the data related to the service is not held, a response signal notifying an absence of the data related to the service is transmitted to the fourth message queue.

5. The control method according to claim 1, further comprising:
attaching a time stamp to at least one of the transmitted update difference data and the data related to the service at the time point of responding to the initialization request signal; and
controlling the transmitting based on a review of the attached time stamp to avoid duplication of all the transmitted data.

6. A non-transitory computer-readable recording medium storing a program that causes a computer to execute a process, the process comprising:
transmitting update difference data generated in response to an update of data related to a service provided by a data user to a first message queue; and
receiving an initialization request signal for the data related to the service from an apparatus of the data user, and transmitting the data related to the service at a time point of responding to the initialization request signal to a second message queue different from the first message queue.

7. The non-transitory computer-readable recording medium according to claim 6,
wherein the process further comprises:
acquiring the initialization request signal from a third message queue different from the first message queue and the second message queue; and
transmitting a response signal to the initialization request signal to a fourth message queue different from the first message queue, the second message queue, and the third message queue.

8. The non-transitory computer-readable recording medium according to claim 6,
wherein the process further comprises:
registering identification information of the data user who has transmitted the initialization request signal in an initializing user list, and executing creation or deletion of the second message queue, based on the identification information registered in the initializing user list.

9. The non-transitory computer-readable recording medium according to claim 6,
wherein the process further comprises:
upon receiving the initialization request signal,
when the data related to the service is held, a response signal notifying that the data related to the service exists is transmitted to the fourth message queue, and the data related to the service at the time point of responding to the initialization request signal is transmitted to the second message queue, and
when the data related to the service is not held, a response signal notifying an absence of the data related to the service is transmitted to the fourth message queue.

10. The non-transitory computer-readable recording medium according to claim 6,
wherein the process further comprises:
attaching a time stamp to at least one of the transmitted update difference data and the data related to the service at the time point of responding to the initialization request signal; and
controlling the transmitting based on a review of the attached time stamp to avoid duplication of all the transmitted data.

11. An information processing apparatus comprising:
a memory; and
a processor coupled to the memory and configured to:
transmit update difference data generated in response to an update of data related to a service provided by a data user to a first message queue; and
receive an initialization request signal for the data related to the service from an apparatus of the data user, and transmit the data related to the service at a time point of responding to the initialization request signal to a second message queue different from the first message queue.

12. The information processing apparatus according to claim 11,
wherein the processor is further configured to:
acquire the initialization request signal from a third message queue different from the first message queue and the second message queue; and
transmit a response signal to the initialization request signal to a fourth message queue different from the first message queue, the second message queue, and the third message queue.

13. The information processing apparatus according to claim 11,
wherein the processor is further configured to:
registering identification information of the data user who has transmitted the initialization request signal in an initializing user list, and executing creation or deletion of the second message queue, based on the identification information registered in the initializing user list.

14. The information processing apparatus according to claim 11,
wherein, upon receiving the initialization request signal,
when the data related to the service is held, a response signal notifying that the data related to the service exists is transmitted to the fourth message queue, and the data related to the service at the time point of responding to the initialization request signal is transmitted to the second message queue, and
when the data related to the service is not held, a response signal notifying an absence of the data related to the service is transmitted to the fourth message queue.

15. The information processing apparatus according to claim 11,
wherein the processor is further configured to:
attach a time stamp to at least one of the transmitted update difference data and the data related to the service at the time point of responding to the initialization request signal; and
control the transmitting based on a review of the attached time stamp to avoid duplication of all the transmitted data.
